(19) United States
(12) Patent Application Publication
(10) Pub. No.: US 2019/0291893 A1
(43) Pub. Date: Sep. 26, 2019

(54) UNMANNED AIRCRAFT AND SYSTEM FOR GENERATING AN IMAGE IN THE AIRSPACE

(71) Applicant: Ars Electronica Linz GmbH & Co KG, Kleinzell (AT)

(72) Inventor: Horst HÖRTNER, Kleinzell (AT)

(21) Appl. No.: 16/316,578

(22) PCT Filed: Jul. 4, 2017
(86) PCT No.: PCT/AT2017/060166

§ 371 Date: Jan. 9, 2019

(30) Foreign Application Priority Data
Jul. 11, 2016 (AT) GM 50137/2016

(51) Int. Cl. B64D 47/02; B64C 39/02; G05D 1/10; G05D 1/00; H04W 4/029

(52) U.S. Cl. CPC B64D 47/02; B64C 39/024; B64C 2201/122; G05D 1/0027; H04W 4/029; G05D 1/104

(57) ABSTRACT

In one example, an unmanned aerial vehicle includes a propulsion unit for enabling the aerial vehicle to fly in the air, and a data processing unit adapted to steer for a position or a temporal sequence of positions of the aerial vehicle in the air essentially in real time based on positional information, where the aerial vehicle includes at least one LASER for emitting and/or manipulating at least one LASER beam and the aerial vehicle includes a communication unit, where the data processing unit is adapted to receive and/or transmit the positional information via the communication unit essentially in real time.

The invention relates to an unmanned aerial vehicle having a propulsion unit for enabling the aerial vehicle to fly in the air and a data processing unit adapted to steer for a position or a temporal sequence of positions of the aerial vehicle in the air essentially in real time based on positional information.

When presenting art or information in the entertainment industry, during public or private events or in general, it is often desirable to provide images in the air. This may, for example, be achieved by using firework, by pulling banners or similar displays with an airplane, by irradiating water fountains with light, by projecting images onto façades of stationary multistory buildings, or by means of colored smoke during air shows.

All exemplary options mentioned above for providing imagines in the air have general and/or specific disadvantages. In the following, some examples of these disadvantages are shown: The use of fireworks entails potential risks, has negative impacts on the environment, and the explosion of fireworks is limited in time and cannot be accurately controlled regarding its position. An airshow entails enormous potential risks, is very expensive, and airplanes usually move way too fast to allow complex or informative images. Pulling a banner has similar disadvantages: The images or information on the banner are static, merely two-dimensional and usually hard to see. Illuminating water fountains with light is limited in height, three-dimensionality and complexity. None of these solutions allows the creation of an image in the air that has a certain minimum height, is repeatable showing essentially the same image, is dynamic, interactive, and reusable.

Developments in the recent years in the technical field of unmanned aerial vehicles, in particular in the field of “drones” or “multicopters,” have led to the use of such aerial vehicles for providing such images in the air.

For example, during the public music event “Klangwolke” on Sep. 1, 2012, in Linz, 49 “quadcopters” were combined to create a dynamic swarm to present dynamic images and visualizations in the air. Every quadcopter had a light diffusion screen and a LED element within the screen. As a result, every quadcopter formed a “picture element” of the image in the air, a so-called “SPAXEL”.

The document U.S. Pat. No. 8,862,285 B2 discloses a comparable system for providing an air image with a plurality of unmanned aerial vehicles, each carrying a controllable LED element within a light diffusing cylinder and thus each serving as a picture element of an image in the air. The LED elements are able to change their colors over time so that the image in the air can also be changed over time.

The two systems mentioned above have the disadvantage that the aerial vehicles used only allow representations of spots, which limits the display options of the image in the air.

An object of the invention is to provide an unmanned aerial vehicle that improves the visibility of an image in the air and its display options.

According to the invention, this object is achieved by an aerial vehicle having at least one LASER means for emitting and/or manipulating at least one LASER beam and by the aerial vehicle having a communication unit, the data processing unit being adapted to receive and/or transmit positional information by means of the communication unit essentially in real time.

A LASER beam is clearly visible even under turbid air conditions and at daylight. By combining or manipulating several LASER beams, complex images with edges, fanned out beams, etc. may be “drawn” into the air. Since LASER beams can be pulsed in a very wide frequency range, with an extremely short duration, and with an accurate repetition frequency, the image in the air may be very dynamic. Consequently, the invention has the advantage that complex and very large images can be provided in the air, which are repeatable with essentially the same image, dynamic and interactive, and which are better visible and have increased display options thanks to their high light intensity.

If the aerial vehicle additionally comprises a communication unit and if the data processing unit is adapted to receive and transmit positional information by means of the communication unit essentially in real time, the aerial vehicle may advantageously be controlled in the air by an external control device, for example a ground control device, essentially in real time, which also allows controlling the image in the air essentially in real time.

If the aerial vehicle additionally comprises a memory unit, wherein the memory unit contains the positional information, and wherein the data processing unit is adapted to receive the positional information from the memory unit and for transmitting the positional information to the memory unit, the aerial vehicle may advantageously be controlled fully automatically in the air, without the need of further interventions in the sequence of positions of the aerial vehicle, so that the image may be displayed in the air essentially fully automatically.

Advantageously, the aerial vehicle is implemented as a drone, for example as a multicopter. That way the aerial vehicle may be acquired and adapted at low cost, and flight stability and controllability through positional information, which may, for example, be three-dimensional GPS coordinates, are accurate and the aerial vehicle may be kept at one position in the air for essentially unlimited time.

In an advantageous embodiment of an aerial vehicle according to the invention, the at least one LASER means is pivotably attached to the aerial vehicle by means of an orientation means allowing pivoting around one axis, preferably two axes, wherein the data processing unit is adapted to control the orientation of the LASER means via the orientation means based on orientation information. Thus, the direction of a LASER beam may be advantageously changed while the aerial vehicle is, for example, kept at a position in the air or is moved from one position in the air to a subsequent position in the air.

In a further advantageous embodiment of an aerial vehicle according to the invention, the at least one LASER means comprises at least one LASER generator, in particular a LASER diode, for emitting the at least one LASER beam. This provides the advantage that the vehicle may itself generate a LASER beam, so that the aerial vehicle, or the LASER means, constitutes the starting point of the LASER beam. Consequently, a LASER generator refers to a light source emitting a highly focused parallel light beam. This strong light beam is, in contrast to light beams of known LED elements or LEDs, often used in the display level of the image in space to represent a line, while light beams of LEDs are oriented essentially perpendicularly to the display level and represent a light spot.

In a further advantageous embodiment of an aerial vehicle according to the invention, the at least one LASER means comprises at least one LASER absorber for absorbing the at least one LASER beam. This provides the advantage that the aerial vehicle may absorb a LASER beam so that the aerial vehicle, or the LASER means, constitutes the end point of the LASER beam.

In a further advantageous embodiment of an aerial vehicle according to the invention, the at least one LASER means comprises at least one LASER reflector, in particular a mirror, for reflecting the at least one LASER beam. This provides the advantage that the aerial vehicle, or the LASER means, may divert or deviate a LASER beam so that the aerial vehicle, or the LASER means, constitutes a deviation point of the LASER beam.

In a further advantageous embodiment of an aerial vehicle according to the invention, the at least one LASER means comprises at least one LASER diffusor for diffusively dispersing the at least one LASER beam or for multiplying, in particular fanning out, the at least one LASER beam into several LASER beams. This leads to the advantage that the aerial vehicle, or the LASER means, may multiply, e.g. fan out, a LASER beam so that the aerial vehicle, or the LASER means, constitutes a deviation point or multiplication point of the LASER beam.

Advantageously at least one unmanned aerial vehicle according to the invention, or more advantageously several unmanned aerial vehicles according to the invention, form a system for creating the image in the air, wherein during an image phase, the image is created in the air by at least one LASER beam emitted and/or manipulated by the at least one aerial vehicle, wherein the positional information, and particularly advantageously also the orientation information, is provided as image information referring to the image.

Advantageously, the data processing units of the aerial vehicles are, by means of the respective communication units, adapted for mutual communication in essentially real time so that the aerial vehicles in the air are controllable in a swarm. This allows the creation of particularly complex and particularly large images in the air by means of a great number of aerial vehicles, for example 100 or more.

A system for creating an image in the air according to the invention may additionally comprise a ground control unit for storing, processing, transmitting and/or receiving the image information, wherein the image information is transmitted by means of a ground communication unit of the ground control unit via the communication units of the aerial vehicles essentially in real time to the data processing units of the aerial vehicles. This allows the creation of particularly complex and particularly large images in the air by means of a great number of aerial vehicles, for example 100 or more, without the aerial vehicles colliding, wherein some of the aerial vehicles or all aerial vehicles are controlled externally by the ground control unit.

In a further advantageous embodiment of a system for creating an image in the air according to the invention, the system additionally comprises a stationary projection surface, for example a façade of a building or a screen positioned in the air by aerial vehicles, onto which the image is projected. This may further increase visibility and/or complexity of the image.

Below, the aerial vehicle, the system and the method according to the invention will be explained in more detail in a non-restrictive manner by means of exemplary embodiments, which are shown in the figures.

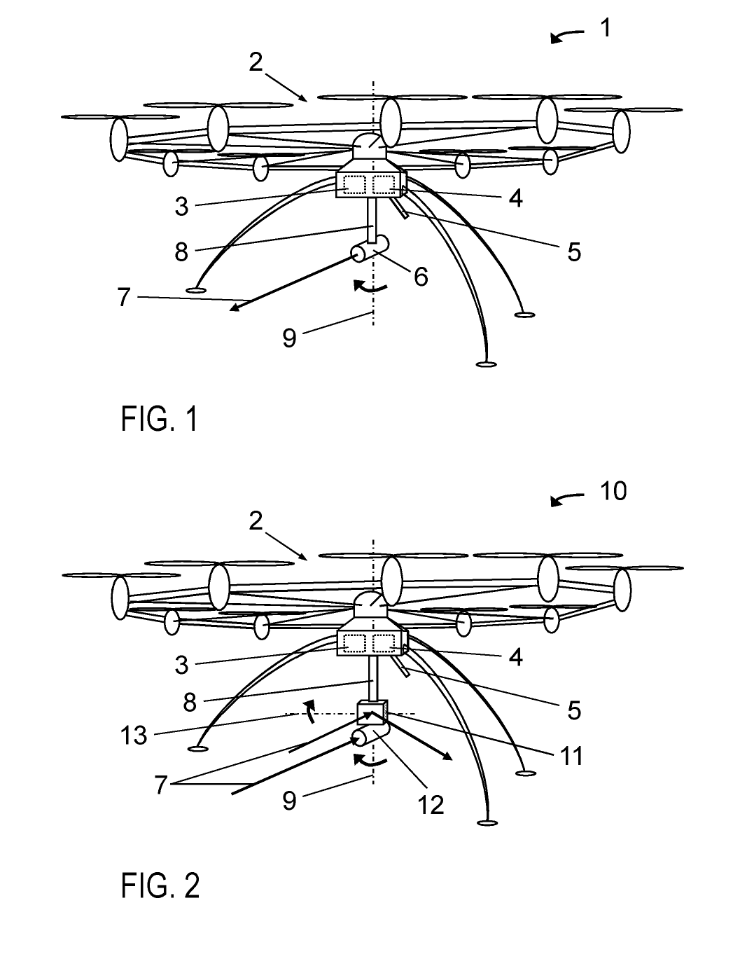

FIG. 1 shows a perspective schematic view of an unmanned aerial vehicle according to a first embodiment of the invention.

FIG. 2 shows a perspective schematic view of an unmanned aerial vehicle according to a second embodiment of the invention.

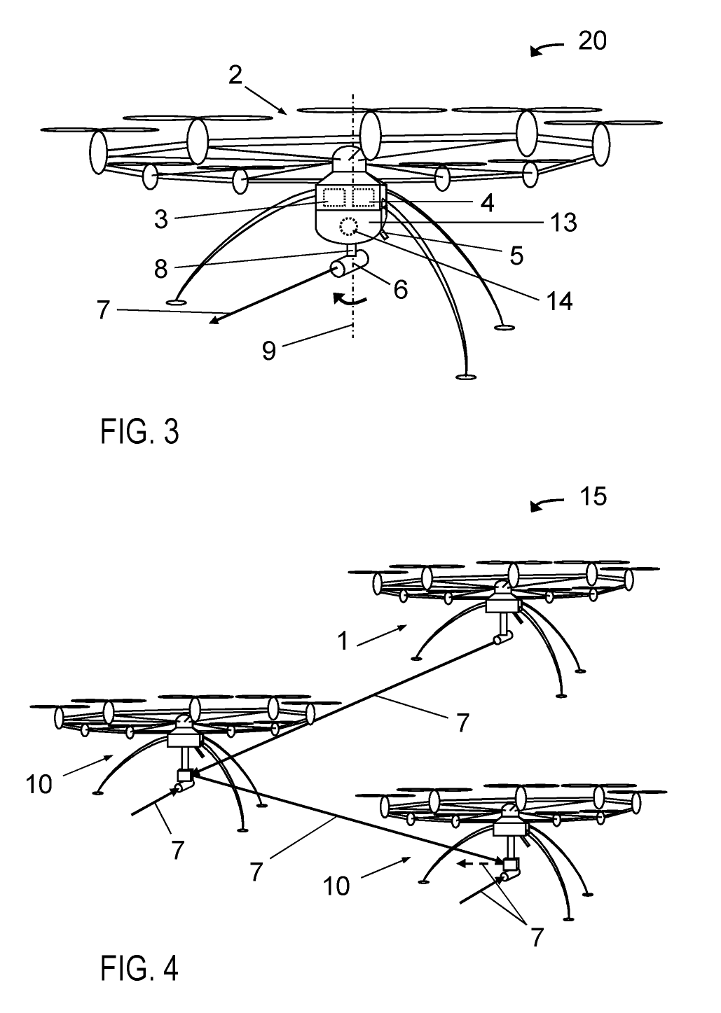

FIG. 3 shows a perspective schematic view of an unmanned aerial vehicle according to a third embodiment of the invention.

FIG. 4 shows a perspective schematic view of a system for creating an image in the air.

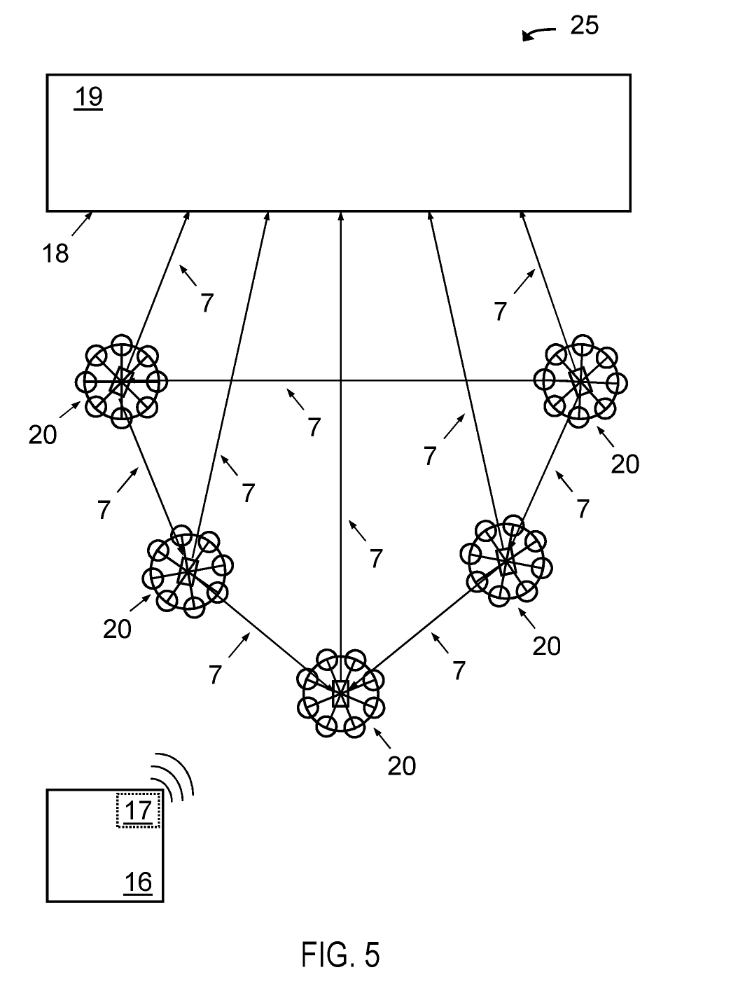

FIG. 5 shows a perspective schematic view from above of a further system for creating an image in the air.

FIG. 1 shows an unmanned aerial vehicle 1 according to a first embodiment of the invention. The aerial vehicle 1 is implemented as a drone, more specifically as a so-called “octocopter”. In this context, a propulsion unit 2 of the aerial vehicle 1 consists of eight rotor units, which are, for example, driven by means of eight electric motors. The propulsion unit 2 allows the aerial vehicle 1 to fly in the air.

An “ocotocopter” is a variation of a “multicopter” having eight rotor units. The aerial vehicle 1 may alternatively be formed as a different variation of a multicopter, for example as a “quadcopter” with four rotor units, etc., wherein essentially any number of rotor units is possible. However, the unmanned aerial vehicle 1 may also be any aerial vehicle stabilizable at its position in the air (e.g. an airship, a balloon and the like).

The term “air” refers to any possible space above artificial or natural ground within or outside of an artificial or natural space or building.

The aerial vehicle 1 further comprises a data processing unit 3, which is adapted to steer for a position or a temporal sequence of positions of the aerial vehicle 1 in the air essentially in real time based on positional information. Positional information is, for example, three-dimensional coordinates in the air based on the “Global Positioning System” (GPS), e.g. data in the GPS exchange format (GPX). The data in the GPX format may contain geodata, i.e. geographic coordinates of latitude, longitude, and height. Alternatively, data may also be based on the Galileo, GLONASS, Beidou/Compass or any other satellite navigation and/or timing system or on a local or building-based navigation system for determining the position of the aerial vehicle within and outside of buildings (e.g. determining the position by means of transmission signals, optical positioning systems, etc.).

The term “temporal sequence of position” essentially refers to a predetermined route or a predetermined “track,” which may also be data in the GPX format. The duration of the temporal sequence determines the flight speed of the aerial vehicle 1. A particular advantage is the possibility to change the “temporal sequence of positions” while the system is running, e.g. by user interaction, or to deduct new positions of one or more aerial vehicles from the user interaction. In this context, it is irrelevant in which manner user interaction is transmitted to the system. Particularly advantageous is the use of a communication unit for transmitting changed positions or changed temporal sequences of positions to the aerial vehicles.

With the data processing unit 3 it is thus possible to steer the aerial vehicle 1 with a certain flight speed to a certain position in the air or along a certain route in the air. To achieve this, the rotors of the propulsion unit 2 are controlled by the data processing unit 3 correspondingly. In addition, the aerial vehicle 1 comprises e.g. a GPS receiver for matching the current position of the aerial vehicle 1 with the predetermined position or route based on the positional information at all times.

“Steering for a temporal sequence of positions of the aerial vehicle 1 in the air” thus refers, inter alia, to steering a movement or flight path of the aerial vehicle 1 in the air, i.e. essentially to controlling the flight of the aerial vehicle 1 in the air.

The positional information is stored in a memory unit 4. The data processing unit 3 receives the positional information from the memory unit 4 and controls the aerial vehicle 1 corresponding to the positional information. In addition, the data processing unit 3 may transfer current positional information to the memory unit 4 where it is stored, for example for monitoring or backup purposes.

In addition, the aerial vehicle 1 comprises a communication unit 5. The data processing unit 3 may thus also receive positional information from an external control device, for example from a laptop, a smartphone or a ground control unit, or send current positional information to such an external control device. In this context, positional information is received or transmitted essentially in real time, which guarantees smooth communication and which allows updating the position in the air, to which the aerial vehicle 1 is to be steered to, at any time.

The communication unit 5 of the aerial vehicle 1 may also be adapted to communicate with the communication unit 5 of a further aerial vehicle 1. This will be explained below.

Furthermore, the aerial vehicle 1 according to the first embodiment of the invention comprises a LASER means. The data processing unit 3 is adapted to control the LASER means. Alternatively, the LASER means may also be controlled by an external control device, for example by a laptop, a smartphone or a ground control unit. The LASER means comprises a LASER generator 6 for emitting a LASER beam 7. In the present case, the LASER generator is the starting point of the LASER beam 7.

Herein, the acronym “LASER” refers to “Light Amplification by Stimulated Emission of Radiation.” The LASER means is thus any imaginable means for emitting or manipulating at least one LASER beam, i.e. a beam consisting of electromagnetic waves with high intensity, optionally narrow frequency range (monochromatic light), a strongly focused beam and large coherence length.

The LASER means, or the LASER generator 6, is attached to an orientation means 8 pivotable at least uniaxially around a symmetry axis 9 of the aerial vehicle 1 and of the orientation means 8, respectively. Pivoting about several axes, for example the horizontal and the vertical axes, as well as rotation around these axes is also advantageous. The data processing unit 3 is adapted to control the orientation of the LASER generator 6 by means of the orientation means 8 based on orientation information.

When the aerial vehicle 1 is at a stable, essentially static position in the air, the symmetry axis 9 is essentially vertical. Alternatively, the orientation of the LASER means may also be determined by the orientation of the aerial vehicle 1 in the air. For example, the orientation of the LASER means may compensate or reinforce a divergent orientation of the aerial vehicle 1.

The orientation information may, for example, comprise angle and time information, i.e. at which angle around the symmetry axis 9 the orientation means 8 shall be oriented at what time. In this context, the orientation information and the positional information may be synchronized with regard to time or space, so that the orientation of the LASER generator 6 may be adapted to the respective current position of the aerial vehicle 1.

The LASER generator 6 can, for example, be a LASER diode. Alternatively, the LASER generator 6 can be any other type of LASER module, LASER source or LASER system for generating and emitting a LASER beam 7.

The LASER generator 6 may be controlled by the data processing unit 3 or the external control device via the communication unit 5. Parameters such as luminous flux, continuous or pulsed emission and/or luminous color can so be changed at any time.

The aerial vehicle 1 according to the invention can thus create an image in the air by means of a LASER beam 7, wherein the image may be varied in space and time through a temporal change of the position of the aerial vehicle 1 in the air based on positional information, and/or via a temporal change of orientation of the orientation means 8 based on the orientation information.

The LASER means can comprise a plurality of LASER generators 6, for example 2 to 10 or more than 10. These LASER generators 6 can be oriented together or independently by means of the orientation means 8 and controlled and changed by means of the data processing unit 3.

FIG. 2 shows an unmanned aerial vehicle 10 according to a second embodiment of the invention. The aerial vehicle 10 is essentially the same as the aerial vehicle 1 according to the first embodiment of the invention. The LASER means are different, which in case of the aerial vehicles 10 according to the second embodiment comprise a LASER reflector 11 and a LASER absorber 12. In addition, the orientation means 8 are pivotable around two axes, namely around the symmetry axis 9 of the aerial vehicle 1 and around a pivot axis 13 of the orientation means 8.

The pivot axis 13 is arranged essentially orthogonally to the symmetry axis 9. When the aerial vehicle 1 is at a stable, essentially static position in the air, the symmetry axis 9 is essentially vertical. The pivot axis 13 is in this case oriented essentially horizontally. The pivot axis 13 may alternatively be oriented in a different way. The orientation means 8 may alternatively be rotatable around any number of axes with any orientation. Alternatively, the orientation of the LASER means may also be determined by the orientation of the aerial vehicle 10 in the air.

The LASER reflector 11, for example a mirror, reflects a LASER beam 7, for example emitted by a LASER generator 6 of a further aerial vehicle 1 or by a LASER generator 6 provided at the ground, in correspondence with the physical laws of optics. The energy or luminous flux of the LASER beam 7 is essentially maintained. The LASER beam 7 is correspondingly diverted or deviated, for example to a further aerial vehicle 10, where it is again deviated or absorbed. The aerial vehicle 10, or the LASER reflector 11, thus constitutes a deviation point of the LASER beam 7.

The LASER absorber 12, for example a beam trap, absorbs a LASER beam 7 emitted, for example, by a LASER generator 6 on the ground. The energy or luminous flux of the LASER beam 7 is essentially emitted as heat. The aerial vehicle 10, or the LASER means, thus constitutes the end point of the LASER beam 7.

FIG. 3 shows an unmanned aerial vehicle 20 according to a third embodiment of the invention. The aerial vehicle 20 is essentially the same as the aerial vehicle 1 according to the first embodiment of the invention. The difference is that the aerial vehicle 20 according to the third embodiment additionally comprises a light diffusion screen 13 as well as controllable LED elements 14 within the light diffusion screen 13. The data processing unit 3 is adapted to control the orientation of the LASER generator 6 by means of the orientation means 8 based on orientation information as well as to control the LED element 14.

The aerial vehicle 20 according to the invention thus forms a diffuse light spot in the air by means of the LED element 14 and the light diffusion screen 13, for example a so-called “SPAXEL,” and is able to create an image in the air by means of this light spot and the LASER beam 7, wherein the image is variable in space and time via a temporal change of position of the aerial vehicle 1 in the air based on the positional information, and/or via a temporal change of orientation of the orientation means 8 based on the orientation information.

If several unmanned aerial vehicles 1, 10 and 20 according to the invention are combined in one system, for example in the form of a swarm, they may be controlled in this formation in order to create images in the air during an image phase. These images may be large and highly visible visualizations and projections in the form of dynamic, three-dimensional figures, which are reusable or repeatable with essentially the same images, dynamic and interactive.

With the aerial vehicle 1, 10 or 20 according to the first, second or third embodiment of the invention, the LASER means may additionally or alternatively comprise a LASER diffusor (not shown in the figures), for example diffractive optical lenses or grids, for diffusely dispersing a LASER beam 7 or for multiplying, particularly fanning out, a LASER beam 7 into several LASER beams 7. The aerial vehicle 1, 10 or 20, or the LASER means, thus constitutes a deviation point or a multiplication point of the LASER beam 7. The energy or luminous flux of the LASER beam 7 is in this case of a multiplication divided into several LASER beams 7.

With regard to the LASER means, any conceivable combination of LASER generator 6, LASER reflector 11, LASER absorber 12, LASER diffusor, light diffusion screen 13 and LED element 14, in and without combination with the orientation means 8 is possible. This means that the LASER means may comprise any combination and number of these devices. In addition, it may comprise further conceivable devices for generating, emitting or manipulating LASER beams, LASER elements, LED elements, further light beams or light elements, etc.

FIG. 4 shows such a system 15 according to the invention consisting of three unmanned aerial vehicles 1 and 10, in which one aerial vehicle 1 according to the first embodiment of the invention and two aerial vehicles 10 according to the second embodiment of the invention are provided. The positional information and the orientation information are provided as image information referring to the image.

Every aerial vehicle 1 and 10 represents a single picture element, and every aerial vehicle 1 and 10 manipulates at least one LASER beam 7 or emits at least one LASER beam 7. The data processing units 3 of the aerial vehicles 1 and 10 mutually communicate via the respective communication units 5 essentially in real time.

FIG. 4 may alternatively show a detail of a system with essentially more aerial vehicles 1, 10 or 20, for example 100 and more aerial vehicles 1, 10 or 20. This allows, based on the advantageous use of LASER beams 7, the creation of particularly complex and particularly large images in the air by means of a large number of aerial vehicles 1, 10 or 20.

FIG. 5 shows a view of a further system 25 consisting of five unmanned aerial vehicles 20 according to the third embodiment of the invention. The system 25 comprises an additional ground control unit 16 adapted to store, process, transmit and/or receive the image information. The image information is transmitted by the ground control unit 16, for example by a ground communication unit 17, via the communication units 5 of the aerial vehicles 20 essentially in real time to the data processing units 3 of the aerial vehicles 20. This allows, based on the advantageous use of LASER beams 7, the creation of particularly complex and particularly large images in the air by means of a large number of aerial vehicles 20, for example 100 and more, without the aerial vehicles 20 colliding, wherein some of the aerial vehicles 20 or all aerial vehicles 20 may be controlled by the ground control unit 16. Alternatively, these aerial vehicles 20 may also fly to these positions independently, without control by a ground unit, by previously storing the positions and their temporal sequence in the aerial vehicle 20.

The system 25 additionally comprises a stationary projection surface 18, a façade of a building 19, onto which a part of the image is projected. Thus, buildings or entire building blocks or landscapes (such as rock walls, ski slopes and the like) may be integrated into the image. The projection surface 18 may alternatively also be a screen positioned in the air by the aerial vehicles 20.

A method according to the invention for creating an image in the air during an image phase via a system 25 will be described below with reference to FIG. 5:

The system 25 is, for example, implemented so that the entire image information is stored in a memory of the ground control unit 16, and this image information is continuously retrieved by control software and transmitted by the ground communication unit 17 and the communication units 5 to the data processing units 3 of the aerial vehicles 20. This means that during the entire image phase the following three process steps A), B) and C) are implemented successively and/or simultaneously with regard to each of the five aerial vehicles 20.

In a process step A), image information, which in the present case comprises positional information and orientation information and is stored in the memory of the ground control unit 16, is transmitted to the data processing units 3 of the aerial vehicles 20 essentially in real time. The data processing units 3 steer, in a process step B), the aerial vehicles 20 in the air essentially in real time to the corresponding positions based on the image information, for example according to FIG. 5. In a subsequent process step C), the data processing units 3 control the LASER means based on the image information and orient them via the orientation means 8. In this context, the data processing units 3 control the LASER generators 6 of the aerial vehicles 20 so that they generate and emit LASER beams 7. Simultaneously, the data processing units 3 control and activate the LED elements 14 of the aerial vehicles 20.

Consequently, all aerial vehicles 20 form a picture element visible from the ground. At the same time, the LASER beams 7 emitted by the LASER generators 6 create a pattern of picture elements on the projection surface 18. The LASER beams 7 emitted by the LASER generators 6 form a line pattern on the projection surface 18 and between the aerial vehicles 20. In this context, the LASER beams 7 extend between the aerial vehicles 20 beyond the position of the respective aerial vehicles 20, or they may alternatively also be absorbed by LASER absorbers 12, which may be additionally comprised by the LASER means of the aerial vehicles 20. This would lead to an image according to FIG. 5. The LASER beams 7 emitted onto the projection surface 18 may, for example, be continuously changed in their direction by means of the LASER generators 6 and the orientation means 8, which creates a dynamic pattern of lines and spots on the projection surface 18.

In a further, new process step A), new image information may now be transmitted by the ground control unit 16 to the data processing units 3 of the aerial vehicles 20. In a further, new process step B), the data processing units 3 steer the aerial vehicles 20 in the air essentially in real time based on the image information to the corresponding new positions in the air. During these process steps, the data processing units 3 can orient the LASER generators 6 in a further, new process step C) based on new image information and orient them via the orientation means 8.

The process steps A), B) and C) may be implemented essentially in real time in any sequence consecutively and/or simultaneously for all aerial vehicles 20 or only for some of the aerial vehicles 20. This allows the creation of three-dimensional and dynamic images in the air consisting of combinations of picture elements and lines. Alternatively, these aerial vehicles may also fly to these positions independently, without control by a ground unit, by previously storing the image information, the positions and their temporal sequence in the aerial vehicle.

It should be mentioned that an aerial vehicle or system according to the invention may be used as an early-warning system in the case of a disaster or as an information system at sports events, such as bicycle races or marathons.

Further, it should be mentioned that a plurality of visualization options is provided by means of the LASER beams of the LASER generator, which does not only allow the creation of lines, but also of surfaces for the image, which may also be moved in the air.

According to a further exemplary embodiment of the invention, an orientation means could additionally or alternatively be attached at the top of an aerial vehicle to emit a LASER beam by means of a LASER generator upwards or obliquely upwards to essentially horizontally from the aerial vehicle. In this context, the aerial could emit a LASER beam pointing upwards into the sky almost endlessly or ending at a LASER absorber of an aerial vehicles flying above it.

According to a further embodiment of the invention, there are at least two aerial vehicles in the air, wherein one aerial vehicle directs a LASER beam to the other one, which ends in the LASER absorber of the other aerial vehicle. In this context, the orientation means of the LASER generator and the LASER absorber must allow as large a freedom of pivoting or movement as possible, i.e. essentially almost 360 degrees over the three spatial axes. If this function is not possible with only one LASER generator and only one LASER absorber because of the construction of the orientation means, it is advisable to provide the aerial vehicle with orientation means with a LASER generator/LASER absorber upwards and downwards. A LASER absorber may also be attached directly to the aerial vehicle without any orientation means and be implemented as a geometrical form (e.g. hemisphere, cone, or polygon) made of LASER beams absorbing material.

According to a further exemplary embodiment of the invention, the LASER means may be formed by a projector, which does not only emit one or more LASER beams, but a real image or a film by means of a LASER generator into the sky onto a cloud or a projection surface. This could allow the implementation of a colossal open-air cinema or warning against e.g. natural disasters for thousands of persons. Also, several aerial vehicles flying next to and above each other could respectively project only partial images, which are assembled on the projection surface. This could substantially improve the resolution of a projected image or film.

According to a further exemplary embodiment of the invention, unmanned aerial vehicles with LASER means could also be controlled in a swarm indoors, for example in a warehouse, in order to display an image in the air within the warehouse or on a projection surface within the warehouse. These aerial vehicles could be controlled from the ground or also via image information stored in memory means of the aerial vehicles.

The LASER means may also be provided in the form of hemispheres, such as known from surveillance cameras, in the interior of which the orientation means and the LASER generator or the LASER absorber may be implemented.

Within the scope of the present invention, the term unmanned aerial vehicle is to be interpreted rather broadly and could, for example, also include hot-air balloons, airships, model airplanes or model helicopters.

1.-15. (canceled)

16. An unmanned aerial vehicle, comprising a propulsion unit for enabling the aerial vehicle to fly in the air, and a data processing unit adapted to steer for a position or a temporal sequence of positions of the aerial vehicle in the air essentially in real time based on positional information, wherein the aerial vehicle comprises a LASER device operable to emit and/or manipulate a LASER beam and the aerial vehicle comprises a communication unit, wherein the data processing unit is adapted to receive and/or transmit the positional information via the communication unit essentially in real time.

17. The aerial vehicle according to claim 16, wherein the aerial vehicle comprises a memory unit, wherein the memory unit contains the positional information, and wherein the data processing unit is adapted to receive the positional information from the memory unit and to transmit the positional information to the memory unit.

18. The aerial vehicle according to claim 16, wherein the aerial vehicle comprises a drone.

19. The aerial vehicle according to claim 16, wherein the LASER device is pivotably attached to the aerial vehicle by way of an orientation device allowing pivoting around one or more axes, wherein the data processing unit is adapted to control the orientation of the LASER device by way of the orientation device based on orientation information.

20. The aerial vehicle according to claim 16, wherein the LASER device comprises a LASER diode operable to generate the LASER beam.

21. The aerial vehicle according to claim 16, wherein the LASER device comprises a LASER absorber configured to absorb the LASER beam.

22. The aerial vehicle according to claim 16, wherein the LASER device comprises a LASER reflector configured to reflect the LASER beam.

23. The aerial vehicle according to claim 16, wherein the LASER device comprises a LASER diffusor operable to diffusively disperse the LASER beam and/or operable to multiply, by fanning out, the LASER beam into several LASER beams.

24. A system operable to create an image in the air, the system comprising two unmanned aerial vehicles, wherein each aerial vehicle comprises a propulsion unit that enables the aerial vehicle to fly in the air, a data processing unit, and a communication unit, wherein the data processing unit is adapted to control a position or a temporal sequence of positions of the aerial vehicle in the air based on positional information and is also adapted to receive and/or transmit the positional information by way of the communication unit in real time, and wherein one of the aerial vehicles comprises a LASER generator operable to emit a LASER beam and that at last one aerial vehicle comprises a LASER device operable to manipulate the LASER beam emitted by the LASER generator of the aerial vehicle, wherein the data processing units are adapted to control the LASER generator and the LASER device during an image phase, the image being created in the air by the emitted and manipulated LASER beam, wherein the positional information is provided as image information referring to the image.

25. The system according to claim 24, wherein one of the unmanned aerial vehicle comprises an orientation device, and during an image phase, the image is created in the air by a LASER beam emitted and/or manipulated by one of the unmanned aerial vehicles, wherein the positional information and the orientation information is provided as image information referring to the image.

26. The system according to claim 24, comprising two unmanned aerial vehicles, wherein the data processing units of the unmanned aerial vehicles are adapted to mutually communicate via the respective communication units essentially in real time, so that the aerial vehicles in the air are controllable in a swarm.

27. The system according to claim 24, wherein the system additionally comprises a ground control unit, which is adapted to store, process, transmit and/or receive the image information, wherein the image information is transmitted by a ground communication unit of the ground control unit via the communication units of the aerial vehicles essentially in real time to the data processing units of the aerial vehicles.

28. The system according to claim 24, wherein the system additionally comprises a stationary projection surface onto which the image is projected.

29. A method for creating an image in the air during an image phase by means of a system according to claim 24, comprising the following operations:
A) transmitting image information to the data processing unit of the aerial vehicle;
B) steering the aerial vehicle in the air by means of the data processing unit essentially in real time based on the image information, wherein before, during or after the operation B) a LASER beam is emitted and/or manipulated via the LASER device.

30. The method according to claim 29, wherein before, during or after the operation B), in an operation C), the LASER device is controlled by the data processing unit via the orientation device based on the image information, and wherein before, during or after the operations B) and/or C) a LASER beam is emitted and/or manipulated by the LASER device.
